(19) United States
(12) Patent Application Publication
(10) Pub. No.: US 2009/0252996 A1
(43) Pub. Date: Oct. 8, 2009

(54) Conveying Device for Conveying Single Separator Plates for Fuel Cells

(76) Inventors: Shigemitsu Nomoto, Aichi-ken (JP); Shiro Akiyama, Aichi-ken (JP)

Correspondence Address: KENYON & KENYON LLP, 1500 K STREET N.W., SUITE 700, WASHINGTON, DC, 20005, US

(21) Appl. No.: 12/083,204

(22) PCT Filed: Oct. 9, 2006
(86) PCT No.: PCT/IB2006/002808

§ 371 Date: Apr. 7, 2008

(30) Foreign Application Priority Data
Oct. 21, 2005 (JP) 2005-307709

(51) Int. Cl. H01M 8/00; H01M 2/02; H01M 2/14

(52) U.S. Cl. 429/13; 429/34; 429/38

(57) ABSTRACT

There is provided a conveying method for attracting and conveying separators for a fuel cell, from a stack of the separators, one at a time. According to the conveying method, when a separator arranged at the top of the separators stacked on top of each other is attracted, gas is supplied into a clearance formed between the separator and another separator arranged immediately below the separator. The clearance is formed due to presence of a seal portion that is formed on the separator so as to protrude therefrom in order to provide sealing to at least one of a fluid passage and a fluid manifold formed in the separator.

### FIELD OF THE INVENTION

The invention relates to a separator that forms part of a fuel cell, and a method and device for conveying the separator.

### BACKGROUND OF THE INVENTION

For example, a polymer electrolyte fuel cell is formed in the following manner. A cell, which is the minimum unit of electric power generation, is formed by sandwiching a membrane electrode assembly (i.e., an “MEA”) between two separators each of which has a fuel gas (hydrogen, etc.) passage and an oxidizing gas (oxygen, etc.) passage in one of its faces. Stacking multiples cells forms a fuel cell stack. The fuel cell stack forms the polymer electrolyte fuel cell.

There has been proposed an automatic supply device that automatically supplies separators for a fuel cell, from a stack of the separators, one at a time to a conveyance line during the process for producing such fuel cell. For example, a method in which separators are attracted, from a stack of the separators, one at a time to an attraction pad is employed as a method for conveying a separator.

In some cases, however, bead-like seal portions are formed on at least one of the faces of the separator in order to provide sealing to the gas passages and fluid (fuel gas, oxidizing gas, coolant) manifolds. In such a case, if the seal portions are compressed due to the weight of the stacked separators, a tack force is produced, causing the separators to adhere to each other. Accordingly, the attraction pad attracts a separator adhering to another separator, in other words, the attraction pad attracts multiple separators adhering to each other. As a result, these multiple separators are conveyed at the same time.

### DISCLOSURE OF THE INVENTION

The invention makes it possible to more reliably convey, one at a time, separators for a fuel cell, which are temporarily stacked on top of each other, for example, in a production process of the fuel cell.

A first aspect of the invention relates to a conveying method for attracting and conveying separators for a fuel cell, from a stack of the separators, one at a time. The conveying method includes a step of separating the adjacent separators from each other by supplying a medium into the clearance formed between the adjacent separators.

According to the conveying method, the pressure in the clearance is increased by supplying the medium (e.g., air or another gas) into the clearance formed between the separators, for example, the clearance formed between the separators due to presence of a seal portion formed on at least one of the faces of the separator so as to protrude therefrom. As a result, the adjacent separators are easily separated from each other.

The clearance may be formed due to presence of a seal portion, which is formed on the separator so as to protrude therefrom in order to provide sealing to at least one of a fluid passage and a fluid manifold formed in the separator.

With this structure, the separators can be separated from each other against a tack force, which is produced between the seal portion and the separator when the separators are stacked on top of each other.

A concave portion, which opens at an outer peripheral face of the separator, and which is formed in a face of the separator so as to extend in the inward direction of the separator from the outer peripheral face, may be formed in advance. The medium may be supplied into the clearance through the concave portion. For example, the concave portion crosses the seal portion when viewed from the top of the separator.

With this structure, the medium can be supplied to a desired position in the clearance formed between the separators. For example, the concave portion may extend so that the end thereof reaches an area surrounded by the seal portions. Thus, the medium can be supplied to the clearance corresponding to the area.

The conveying method may include a step of attracting the separator using a separator conveying device while a separator attraction face of the separator conveying device is pressed to an attraction target face of the separator with the separator attraction face tilted with respect to the attraction target face.

When the separator is attracted using the separator conveying device while the separator attraction face of the separator conveying device is pressed to the attraction target face of the separator, a peripheral portion of the attraction target face of the separator, which is on the outer side of a center portion of the attraction target face, is curved (deformed) in the direction opposite to the direction in which the separator attraction face is pressed to the attraction target face (i.e., curved in the direction in which the separator attracted to the separator attraction face is moved away from the other separators). As a result, the separators are easily separated from each other.

A second aspect of the invention relates to a separator conveying device that attracts and conveys separators for a fuel cell, from a stack of the separators, one at a time. The conveying device includes an attraction portion that attracts the separator; and a medium supply portion that supplies a medium into the clearance formed between the adjacent separators.

With the separator conveying device, when the separator is attracted to be separated from the other separators, the medium (e.g. air or another gas) is supplied from the medium supply portion into the clearance formed between the separators, for example, the clearance formed between the separators due to presence of a seal portion formed on at least one of the faces of the separator so as to protrude therefrom. Thus, the pressure in the clearance is increased. As a result, the separators are easily separated from each other.

The attraction portion may contact and move away from the separators stacked on top of each other, and have a separator attraction face that is tilted with respect to an attraction target face of the separator.

When the separator is attracted using the separator conveying device while the separator attraction face of the separator conveying device is pressed to the attraction target face of the separator, a peripheral portion of the attraction target face of the separator, which is on the outer side of a center portion of the attraction target face, is curved (deformed) in the direction opposite to the direction in which the separator attraction face is pressed to the attraction target face (i.e., curved in the direction in which the separator attracted to the separator attraction face is moved away from the other separators). As a result, the separators are easily separated from each other.

A third aspect of the invention relates to a separator that forms part of a fuel cell. The separator has a concave portion, which opens at an outer peripheral face of the separator, and which is formed in a face of the separator so as to extend in the inward direction of the separator from the outer peripheral face.

With this structure, when the separators are attracted and conveyed, from a stack of the separators, one at a time, the medium is supplied into the clearance formed between the concave portion. As a result, the separators are easily separated from each other.

A fourth aspect of the invention relates to a separator conveying device that attracts and conveys separators for a fuel cell, from a stack of the separators, one at a time. The separator conveying device includes an attraction portion that attracts a separator present at a top of the stacked separators. The attraction portion contacts and moves away from the separator present at the top of the stacked separators, and has a separator attraction face that is tilted with respect to an attraction target face of the separator present at the top of the stacked separators.

The invention makes it possible to more reliably attract and convey the separators, from the stack of the separators, one at a time. As a result, the fuel cell is produced more efficiently.

### BRIEF DESCRIPTION OF THE ATTRACTIONS

The foregoing and further objects, features and advantages of the invention will become apparent from the following description of example embodiments with reference to the accompanying attractions, wherein the same or corresponding portions will be denoted by the same reference numerals and wherein:

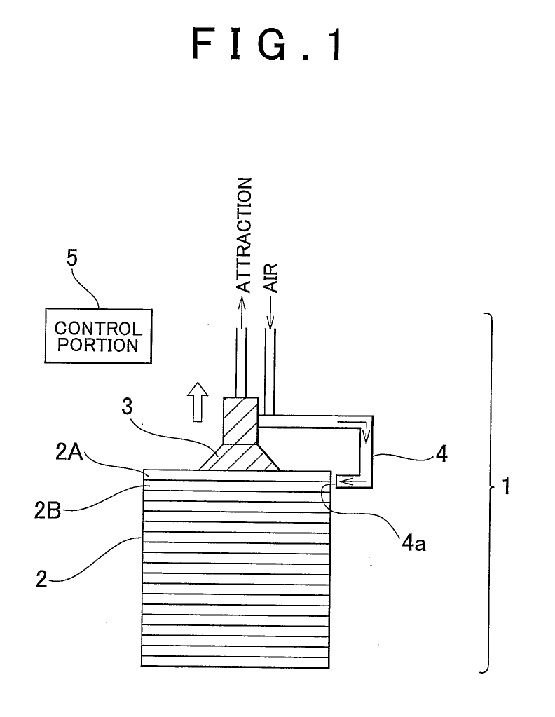

FIG. 1 is the view schematically showing a separator conveying device according to a first embodiment of the invention;

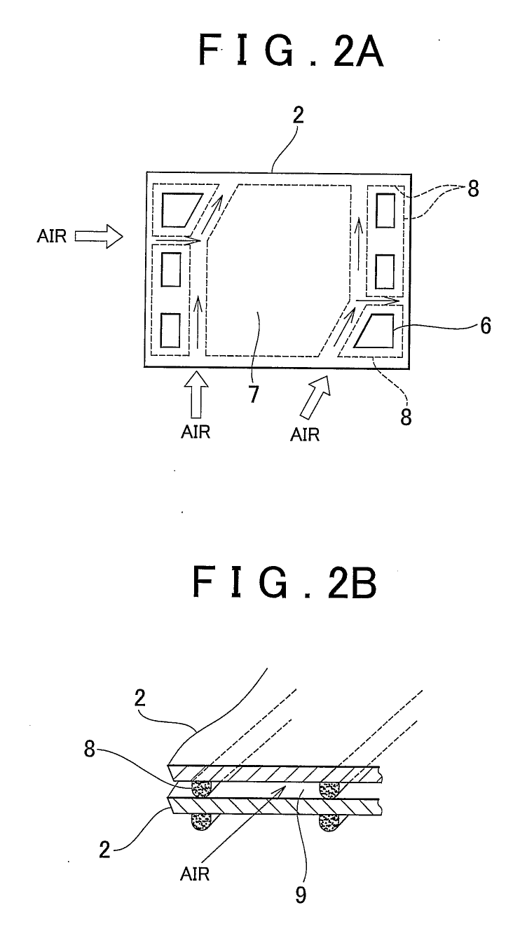

FIGS. 2A and 2B are the views schematically showing the structure of a separator;

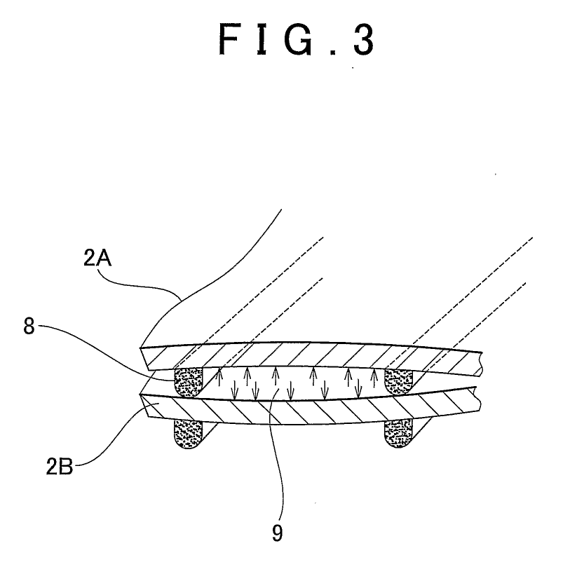

FIG. 3 is the view showing the state where air is supplied into a clearance between the adjacent separators by the separator conveying device according to the first embodiment of the invention;

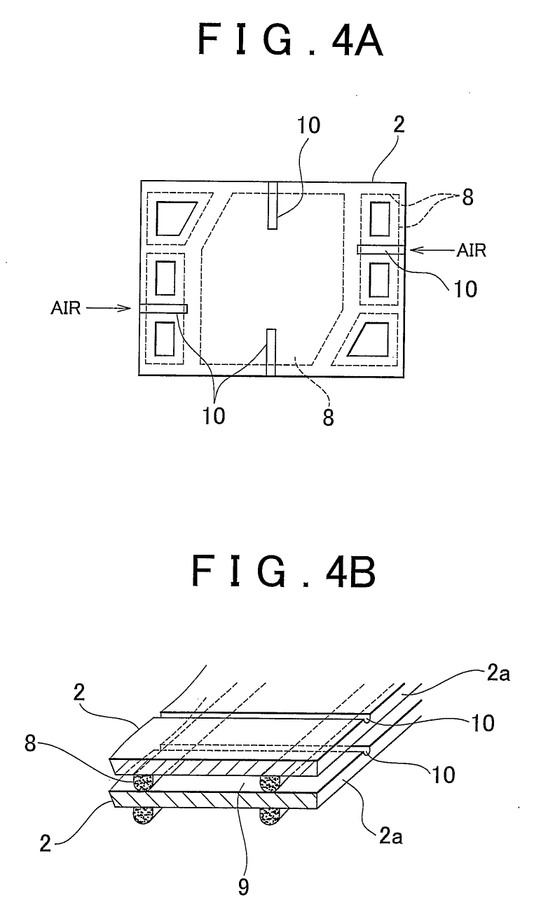

FIGS. 4A and 4B are the plan view and the perspective view, respectively, schematically showing the separator in which concave portions are formed;

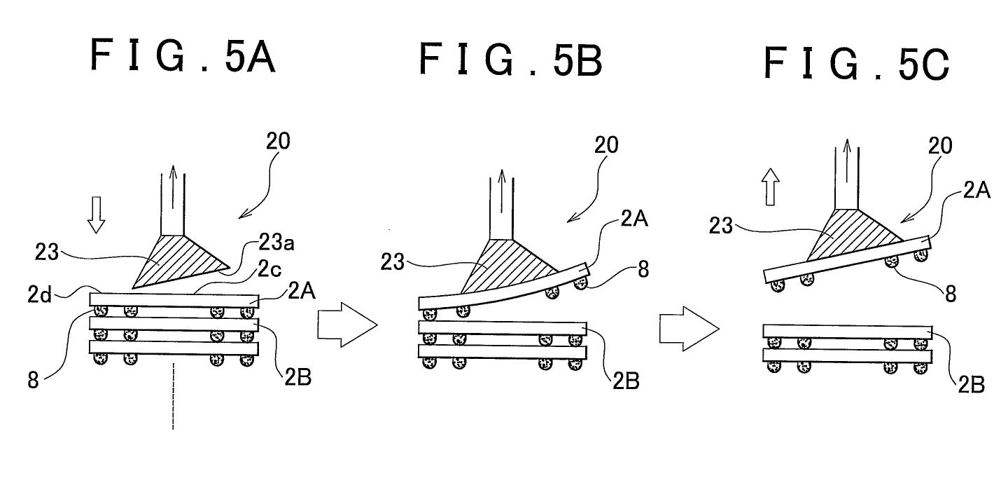

FIGS. 5A to 5C are the views for describing the case where the separator is attracted using a separator conveying device according to a third embodiment of the invention;

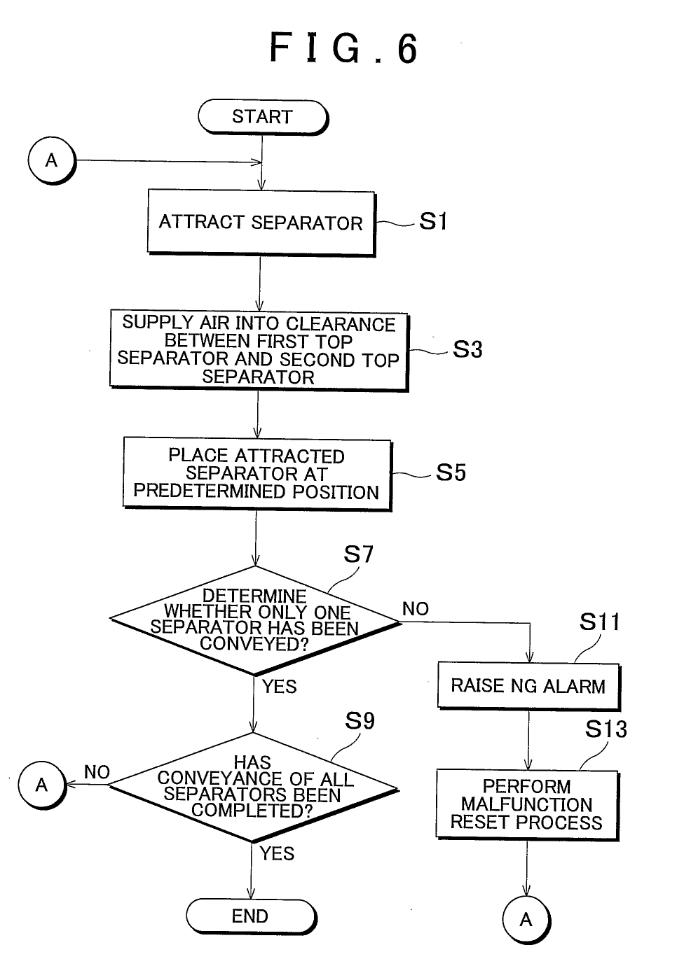

FIG. 6 is the flowchart of a separator conveying method according to a fourth embodiment of the invention; and

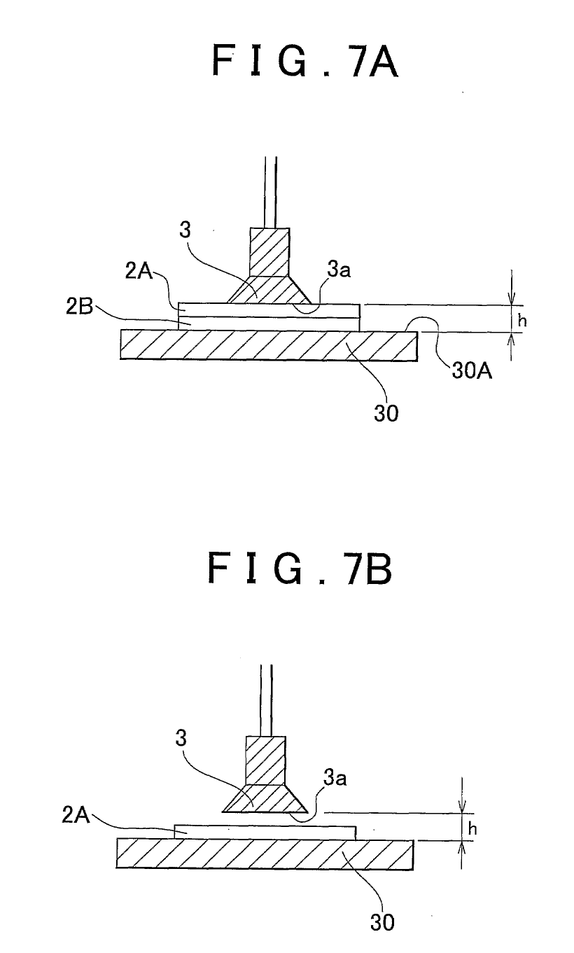

FIGS. 7A and 7B are the views for describing the case where whether two separators have been attracted is determined by the separator conveying method according to the fourth embodiment of the invention.

### DETAILED DESCRIPTION OF THE PREFERRED EMBODIMENTS

Hereafter, a first embodiment of the invention will be described in detail. FIG. 1 shows a device 1 for conveying a separator (hereinafter, referred to as a “separator conveying device 1”) according to the first embodiment of the invention. The separator conveying device 1 in FIG. 1 includes an attraction pad (attraction portion) 3 that attracts separators 2, from a stack of the separators 2, one at a time from a separator 2A present at the top of the stacked separators 2 (hereinafter, referred to as a “first top separator 2A); an attraction mechanism (not shown) that supplies a negative pressure to the attraction pad 3; a drive mechanism (not shown) that drives the attraction pad 3 in a predetermined direction; an air pipe 4 (a medium supply portion) that supplies air (a medium) into a clearance formed between the separators 2, 2; an air-supply mechanism (a medium supply portion) (not shown) that supplies the air into the air pipe 4; and a control portion 5 that controls these mechanisms.

The attraction pad 3 attracts the separator 2 using the negative pressure produced by the attraction mechanism. The attraction pad 3 is moved away from the separators 2 other than the separator 2 attracted to the attraction pad 3 and turned by the drive mechanism. Thus, the separator 2 attracted to the attraction pad 3 is conveyed to a predetermined destination (for example, a conveyance jig).

The air pipe 4 is fixed to the attraction pad 3 such that an opening portion 4a faces a clearance 9 formed between the first top separator 2A and another separator 2B present immediately below the first top separator 2A (hereinafter, referred to as a “second top separator 2B”) when the attraction pad 3 contacts the first top separator 2A to attract it. With this structure, when the attraction pad 3 contacts the first top separator 2A to attract it, air from the opening portion 4a can be supplied, from the side of the separator 2, into the clearance 9.

As shown in FIG. 2A, bead-like seal portions 8 are formed on one of the faces of the separator 2. The bead-like seal portions 8 protrude from the face on which they are formed. The bead-like seal portions 8 are formed to provide sealing to a fuel gas manifold (fluid manifold), an oxidizing gas manifold (fluid manifold), a coolant manifold (fluid manifold) 6, a fuel gas passage (fluid passage) 7, an oxidizing gas passage (fluid passage), and a coolant passage (fluid passage).

As shown in FIG. 2, the separators 2 are stacked on top of each other with the clearance 9 reserved therebetween. The clearance 9 is formed between the adjacent separators 2, 2 due to presence of the seal portions 8.

The separators 2 are conveyed by the separator conveying device 1 according to the first embodiment of the invention in the following manner. First, from a stack of the multiple separators 2, the first top separator 2A is attracted to the attraction pad 3. At this time, the opening portion 4a of the air pipe 4 faces the clearance 9 formed between the first top separator 2A and the second top separator 2B. Next, air is supplied into the clearance 9 from the air pipe 4.

The clearance 9 is formed between the first top separator 2A and the second top separator 2B due to the presence of the seal portions 8. The air is supplied into the clearance 9. As shown in FIG. 3, when the air is supplied into the clearance 9, the pressure in the clearance 9 is increased due to the fluid resistance in an air passage formed between the seal portions 8, and a force (indicated by the arrows in FIG. 3) for separating the seal portions 8 of the first top separator 2A from the second top separator 2B is produced. Therefore, the second top separator 2B is separated from the first top separator 2A, and only the first top separator 2A is conveyed to the predetermined destination.

According to the first embodiment of the invention described above, it is possible to effectively avoid the situation where two or more separators 2 adhere to each other due to a tack force of the seal portions 8 and are conveyed while being overlaid with each other. Accordingly, it is possible to prevent the situation where two or more separators 2 overlaid with each other are sent, at the same time, to the next production step. As a result, the fuel cell can be produced more efficiently.

Hereafter, a second embodiment of the invention will be described in detail. As shown in FIG. 4A, grooves (concave portions) 10 are formed in the separator 2 for a fuel cell according to the second embodiment of the invention. Each of the grooves 10 opens at an outer peripheral face 2a of the separator 2. Each groove l is formed in one of the faces of the separator 2 so as to extend in the inward direction of the separator from the outer peripheral face 2a. As shown in FIG. 4B, the groove 10 is formed so as to cross the seal portions 8 of the adjacent separator 2. Namely, the groove l is formed in the face opposite to the face on which the seal portions 8 are formed. When viewed from the top of the separator 2, the groove 10 crosses the seal portions 8 formed in the same separator 2.

Part (two in FIG. 4A) of the multiple grooves 10 extend so that the ends thereof reach an area surrounded by the seal portions 8. With this structure, the air can be supplied, through the groove 10, even into the clearance 9 formed in the area surrounded by the seal portions 8 when the cells 2 are stacked on top of each other.

According to the second embodiment of the invention, it is possible to increase the pressure in the clearance 9 corresponding to the area surrounded by the seal portions 8, as well as the pressure in the clearance 9 formed between the seal portions 8. Thus, the seal portions 8 of the first top separator 2A can be separated from the second top separator 2B more easily.

Hereafter, a third embodiment of the invention will be described in detail. As shown in FIG. 5A, a separator conveying device 20 according to the third embodiment of the invention is formed such that a separator attraction face 23a of an attraction pad 23, which attracts the separators 2, from a stack of the separators 2, one at a time from the first top separator 2A, is tilted with respect to an attraction target face 2c of the first top separator 2A by a predetermined angle. Namely, the attraction pad 23 has a shape that is obtained by cutting the bottom portion of a circular truncated cone along a face tilted with respect to the bottom face of the circular truncated cone. The other portions of the third embodiment are the same as those in the embodiments described above. Accordingly, the same portions as those in the embodiments described above will be denoted by the same reference numerals, and will not be described in detail below. In the third embodiment of the invention, the separator conveying device 20 need not be provided with the air pipe 4, which is used in each of the first and the second embodiments of the invention. However, the separator conveying device 20 may be provided with the air pipe 4, in the third embodiment of the invention.

The separator 2 is conveyed, in the following manner, by the separator conveying device 20 according to the third embodiment of the invention. First, from the stack of the multiple separators 2, the first top separator 2A is attracted to the attraction pad 23.

The attraction pad 23 is tilted with respect to the attraction target face 2c of the first top separator 2A. Accordingly, when the attraction pad 23 attracts the first top separator 2A while the separator attraction face 23a is pressed to the attraction target face 2c of the first top separator 2A, the center portion of the attraction target face 2c of the first top separator 2A is dented in the direction in which the separator attraction face 23a is pressed to the attraction target face 2c. At the same time, a peripheral portion 2d, which is in the attraction target face 2c and on the outer side of the center portion, is curved (deformed) in the direction opposite to the direction in which the separator attraction face 23a is pressed to the attraction target face 2c.

Due to such curvature, a force for separating the seal portions 8 of the first top separator 2A from the second top separator 2B is produced in the first top separator 2A, as shown in FIG. 5B. Thus, the first top separator 2A is separated from the second top separator 2B, and only the first top separator 2A is conveyed to the predetermined destination.

According to the third embodiment of the invention as well, it is possible to effectively avoid the situation where two or more separators 2 adhere to each other due to a tack force of the seal portions 8 and are conveyed while being overlaid with each other. Accordingly, it is possible to prevent the situation where two or more separators 2 overlaid with each other are sent, at the same time, to the next production step. As a result, the fuel cell can be produced more efficiently.

Hereafter, a fourth embodiment of the invention will be described in detail. The control portion 5 may perform the following control routine in order to determine whether the attraction pad 3, 23 of the separator conveying device 1, 20 has attracted two more separators 2 at the same time. A description will be given concerning an example in which the configuration of the fifth embodiment is applied to the separator conveying device according to any one of the first to the third embodiments of the invention. However, the configuration of the fifth embodiment may be applied to conventional separator conveying devices. The same portions as those in the first embodiment will be denoted by the same reference numerals, and will not be described in detail below.

FIG. 6 shows the control routine performed by the control portion 5 according to the fifth embodiment of the invention. First, the attraction pad 3 attracts the first top separator 2A (step S1). At this time, the opening portion 4a of the air pipe 4 faces the clearance 9 formed between the first top separator 2A and the second top separator 2B, and the air is supplied into the clearance 9, as described above (step S3).

Thus, the second top separator 2B is separated from the first top separator 2A. In step S3, instead of attracting the first top separator 2A by supplying the air into the clearance 9, the attraction pad 23 may attract the first top separator 2A while the separator attraction face 23a of the attraction pad 23 is pressed to the attraction target face 2c of the first top separator 2A with the separator attraction face 23a tilted with respect to the attraction target face 2c, as described in the third embodiment of the invention.

Next, the first top separator 2A attracted to the attraction pad 3 is placed at a predetermined position of the destination (step S5). Then, whether two or more separators 2 have been attracted to the attraction pad 3 and conveyed to the destination at the same time is determined in the following manner (step S7). More specifically, as shown in FIG. 7, the separator attraction face 3a of the attraction pad 3 is positioned above the first top separator 2A placed on a conveyance jig 30, at the position at a height h, corresponding to the thickness of the two separators 2, from an upper face 30A of a conveyance jig 30. An attraction process is then performed by the attraction mechanism.

If the first top separator 2A is attracted to the attraction pad 3, the controller 5 detects a negative pressure. When the control portion 5 detects such negative pressure, it is determined that two separators 2 (the separators 2A and 2B) have been conveyed at the same time, as shown in FIG. 7A. In contrast, when only the first top separator 2A has been conveyed as shown in FIG. 7B, the first top separator 2A is not attracted to the attraction pad 3. As a result, a negative pressure is not produced.

As described above, the control portion 5 determines whether two separators 2 have been conveyed by determining whether a negative pressure is produced when the attraction process is performed with the separator attraction face 3a of the attraction pad 3 arranged at the position corresponding to the height h from the upper face 30A of the conveyance jig 30. Whether three or more separators 2 have been conveyed at the same time can be determined by appropriately changing the height h.

When it is determined in step S7 that only the first top separator 2A has been conveyed (“YES” in step S7), it is then determined whether conveyance of all the separators 2 has been completed (step S9). If it is determined that conveyance of all the separators 2 has not been completed (“NO” in step S9), step 1 and the following steps are performed again. On the other hand, when it is determined that conveyance of all the separators 2 has been completed (“YES” in step S9), the control routine for conveying the separators 2 ends.

When it is determined in step S7 that two separators 2 have been conveyed (“NO” in step S7), a warning is given to a user, for example, by raising an NG alarm (step S11). Then, a malfunction reset process is performed, for example, one of the two separators 2 placed on the conveyance jig 30 is manually taken out and returned to the original position. Then, step S1 is performed again.

According to the fourth embodiment of the invention described above, it is possible to effectively avoid the situation, where two or more separators 2 adhere to each other due to a tack force of the seal portions 8 and are conveyed while being overlaid with each other. In addition, even if two or more separators 2 have been accidentally conveyed, performing step S7 reliably prevents the situation where two or more separators 2 overlaid with each other are sent, at the same time, to the next production step.

1. A conveying method for attracting and conveying separators for a fuel cell, from a stack of the separators, one at a time, comprising:
separating the adjacent separators from each other by supplying a medium into a clearance formed between the adjacent separators.

2. The conveying method according to claim 1, wherein
the clearance is formed due to presence of a seal portion, which is formed on the separator so as to protrude from the separator in order to provide sealing to at least one of a fluid passage and a fluid manifold formed in the separator.

3. The conveying method according to claim 1, wherein
the medium is supplied into the clearance through a concave portion, which opens at an outer peripheral face of the separator, and which is formed in a face of the separator so as to extend in an inward direction of the separator from the outer peripheral face.

4. The conveying method according to claim 1, further comprising the step of:
attracting the separator using a separator conveying device while a separator attraction face of the separator conveying device is pressed to an attraction target face of the separator with the separator attraction face tilted with respect to the attraction target face.

5. A separator conveying device that attracts and conveys separators for a fuel cell, from a stack of the separators, one at a time, comprising:
an attraction portion that attracts the separator; and
a medium supply portion that supplies a medium into a clearance formed between the adjacent separators, wherein.
a separator attraction face of the separator is pressed to an attraction target face of the separator with the separator attraction face tilted with respect to the attraction target face.

6. (canceled)

7. A separator that forms part of a fuel cell, comprising,
a concave portion, which opens at an outer peripheral face of the separator, and which is formed in a face of the separator so as to extend in an inward direction of the separator from the outer peripheral face, further comprising
a seal portion formed on at least one face of the separator so as to protrude from the at least one face of the separator in order to provide sealing to at least one of a fluid passage and a fluid manifold formed in the separator,
wherein the concave portion is formed in a face opposite to the face on which the seal portion is formed, and the concave portion crosses the seal portion when viewed from a top of the separator.

8. (canceled)

9. A separator conveying device that attracts and conveys separators for a fuel cell, from a stack of the separators, one at a time, comprising:
an attraction portion that attracts a separator present at a top of the stacked separators, wherein
the attraction portion contacts and moves away from the separator present at the top of the stacked separators, and has a separator attraction face that is tilted with respect to an attraction target face of the separator present at the top of the stacked separators, wherein
the attraction portion includes an attraction pad that has a shape which is obtained by cutting a bottom portion of a circular truncated cone along a face tilted with respect to a bottom face of the circular truncated cone.

10. (canceled)

11. A method for conveying a separator for a fuel cell, comprising:
attracting separators for a fuel cell, from a stack of the separators, one at a time; and
separating the adjacent separators from each other by supplying a medium into a clearance formed between the adjacent separators.
